(19) United States
(12) Patent Application Publication
(10) Pub. No.: US 2018/0209205 A1
(43) Pub. Date: Jul. 26, 2018

(54) FLASHING PANEL FOR ELECTRICAL BOX

(71) Applicant: WJG, LLC, Las Vegas, NV (US)

(72) Inventors: William J. Gilleran, Las Vegas, NV (US); Craig Ratajczyk, Las Vegas, NV (US)

(21) Appl. No.: 15/824,880

(22) Filed: Nov. 28, 2017

Related U.S. Application Data
(60) Provisional application No. 62/450,408, filed on Jan. 25, 2017.

(51) Int. Cl. E06B 1/62; H02G 3/08; H02G 3/10

(52) U.S. Cl. CPC E06B 1/62; E06B 2001/628; H02G 3/10; H02G 3/088

(57) ABSTRACT

A flashing panel is provided for use with an electrical junction box having a boarder having a defined contour. The flashing panel includes a panel body having a first surface, an opposing second surface, and a panel body opening extending from the first surface to the second surface. A resilient seal element is coupled to the panel body and extends radially inward from the panel body into the panel body opening. The resilient seal element includes a seal element opening having a defined contour complimentary to the defined contour of the boarder of the electrical junction box, the seal element opening being sized to allow the electrical junction box to at least partially extend therethrough, with the resilient seal element deforming as the electrical junction box is extended through seal element opening so as to form a fluid tight seal around the boarder of the electrical junction box.

### CROSS-REFERENCE TO RELATED APPLICATIONS

This application claims the benefit of U.S. Provisional Application No. 62/450,408, filed Jan. 25, 2017, the content of which is expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a flashing panel, and more specifically to a flashing panel having a central elastomeric sealing element adapted to form a fluid tight seal about an electrical box.

### 2. Description of the Related Art

In the construction of houses, commercial buildings, and the like, various electrical boxes, and other utilities, extend through the walls of the building and terminate outside the building so as to be accessible by a user. When exteriorly terminated, these electrical boxes extend through insulation, between wall boards, potentially within ceiling and floor structures, and in other critical places where a dry environment is extremely important for both structural and safety considerations. The exteriorly exposed ends of the electrical boxes are periodically subjected to water sources, whether from rain, snow, lawn sprinklers, vandalism, or other sources. Such water has a natural tendency to travel rearwardly on the exterior of the electrical box for attempted entry into the building structure. If such water enters through the exterior building wall, it can cause substantial damage to insulation, dry wall, wood moldings, flooring, and carpeting on the interior of the building.

The importance of attempting to mitigate water entry along the electrical box has been recognized by the building industry with various attempts being recently made to prevent such rearward water travel. One presently employed approach utilizes caulking material applied at the interface of the electrical box with lathing paper disposed immediately behind an exposed portion of the electrical box. Thereafter, stucco or other exterior finish material is applied over the lathing paper to be adjacent to the exposed portion of the electrical box while allowing the pipe end to be exteriorly accessible. Over time, however, such caulking can eventually crack and break, and when this occurs, water can freely travel along the outer surface of the electrical box and into the interior of the building structure.

A second common approach is individually performed at every pipe outlet at a job site and entails hand measuring and cutting of sheet metal to create flashing thereafter fitted around the electrical box and nailed in place and caulked. Once again, although this approach can work initially, the caulking material eventually gives way or is not initially caulked properly, which allows water to travel rearwardly over the outer surface of the electrical box and into the structure.

Accordingly, there is a need in the art for a more user friendly and durable flashing products for use with electrical boxes to mitigate unwanted passage of moisture into a building. Various aspects of the present disclosure address this particular need, as will be discussed in more detail below.

### BRIEF SUMMARY

In accordance with one embodiment of the present disclosure, there is provided a flashing panel for use with an electrical junction box including a boarder having a defined contour. The flashing panel includes a panel body having a first surface, an opposing second surface, and a panel body opening extending from the first surface to the second surface. A resilient seal element is coupled to the panel body and extends radially inward from the panel body into the panel body opening. The resilient seal element includes a seal element opening having a defined contour complimentary to the defined contour of the boarder of the electrical junction box, the seal element opening being sized to allow the electrical junction box to at least partially extend therethrough, with the resilient seal element deforming as the electrical junction box is extended through seal element opening so as to form a fluid tight seal around the boarder of the electrical junction box.

The panel body may be formed from a polymeric material. The panel body may define a quadrangular boarder. The panel body may be generally rigid.

The resilient seal element may be formed from an elastomeric material. The resilient seal element may be formed from a water resistant material. The seal element opening may be quadrangular. The resilient seal element may include an annular attachment element engaged with the panel body. The annular attachment element may include a first flange extending along a portion of the first surface of the panel body, and a second flange extending along a portion of the second surface of the panel body, with the first and second flanges defining an attachment cavity therebetween, and the panel body being received within the attachment cavity.

According to another embodiment, there is provided a flashing panel comprising an outer element and a resilient inner element. The outer element has a first opening formed therein, with the outer element being of a first rigidity. The resilient inner element is coupled to the outer element and extends radially inward from the outer element into the first opening, with the resilient inner element including a second opening having a defined contour complimentary to the defined contour of the boarder of the electrical junction box. The second opening is sized to allow the electrical junction box to at least partially extend therethrough, with the resilient inner element deforming as the electrical junction box is extended through the second opening so as to form a fluid tight seal around the boarder of the electrical junction box. The resilient inner element is of a second rigidity less than the first rigidity.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a plan view of an embodiment of a flashing panel having a central elastomeric sealing member adapted to form a circumferential seal around an electrical box;

FIG. 2 is a cross sectional view of the flashing panel depicted in FIG. 1;

FIG. 3 is a perspective view of the flashing panel of FIG. 1 aligned with an electrical box extending through a shear panel;

FIG. 4 is a perspective view of the flashing panel of FIG. 3 coupled to the shear panel, with the electrical box extending through the flashing panel;

FIG. 5 is a perspective view of the flashing panel of FIG. 4, with a first weather resistant barrier positioned between the flashing panel and the shear panel; and

FIG. 6 is a perspective view of the flashing panel having a second weather resistant barrier positioned over the flashing panel.

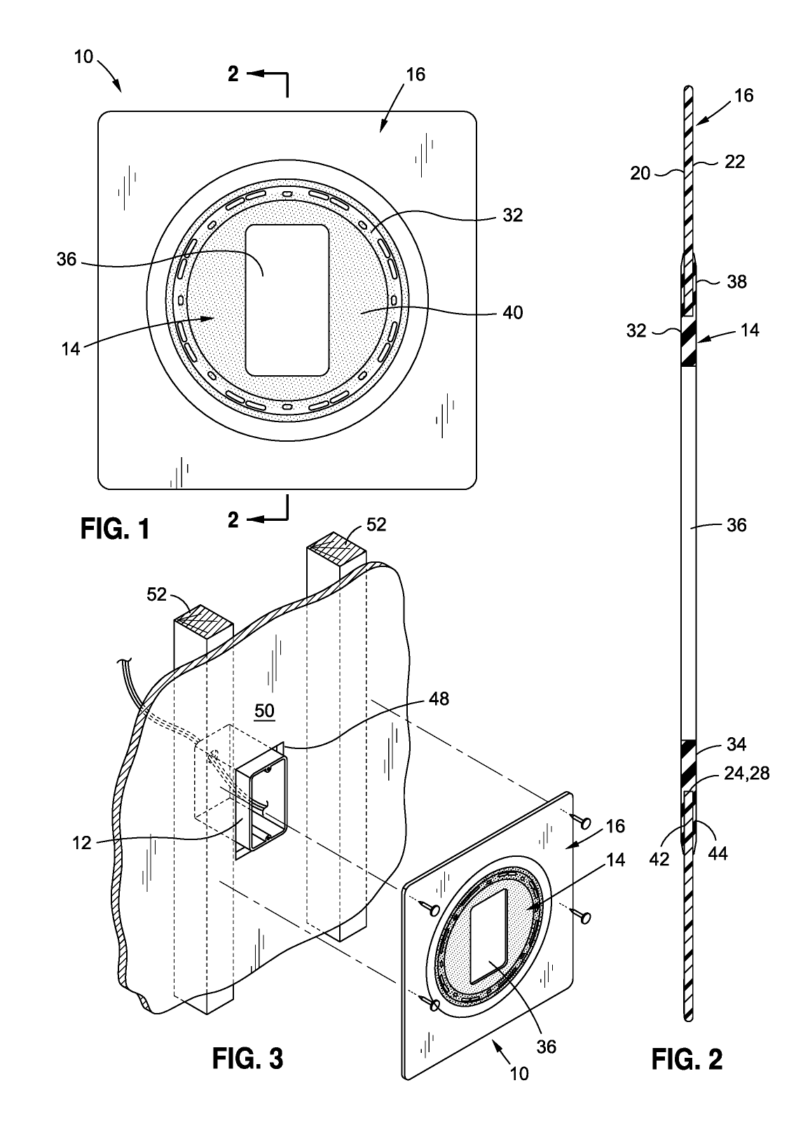

Common reference numerals are used throughout the drawings and the detailed description to indicate the same elements.

### DETAILED DESCRIPTION

The detailed description set forth below in connection with the appended drawings is intended as a description of certain embodiments of a flashing panel and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating a preferred embodiment of the present disclosure, and are not for purposes of limiting the same, there is depicted a flashing panel 10 specifically configured and adapted to for use with an electrical junction box 12 extending through a wall of a building or structure. As will be described in more detail below, the flashing panel 10 is formed with a resilient seal element 14 that conforms to the defined contour of the electrical junction box 12 to form a fluid tight seal therebetween. The seal is formed through the interaction between the resilient, flexible seal element 14 of the flashing panel 10 and the outer surface of the electrical junction box 12. In this regard, the flashing panel 10 provides a weatherproofing barrier around the electrical junction box 12 to protect against moisture intrusion into the building or structure along the outer surface of the electrical junction box 12.

The electrical junction box 12 (or electrical box) is a conventional electrical junction box designed for use as a container or housing for electrical connections, and may house electrical wiring, electrical switches, or other electrical components. The electrical junction box 12 includes an outer boarder having a defined contour, the importance of which will be discussed herein. The electrical junction box 12 may be formed of a polymeric material, metal material, or other materials known in the art. Furthermore, although the electrical junction box 12 depicted in the Figures includes a rectangular outer contour, it is understood that the electrical junction box 12 may define other shapes (i.e., circular, square, etc.), and may be available in several different sizes.

Accordingly to one embodiment, the flashing panel 10 includes a panel body 16 having a first surface 20, an opposing second surface 22, and a panel body opening 24 extending from the first surface 20 to the second surface 22. In this regard, the panel body 16 includes an inner edge 28 defining the panel body opening 24. The panel body 16 is preferably formed from material having a certain degree of stiffness and rigidity, while at the same time allowing for a degree of flexion or flexibility. An example of such a material is a polymeric material, although other materials known in the art may also be used. Various embodiments of the panel body 16 may be more flexible than others, depending on the material used to fabricate the panel body 16. The panel body 16 depicted in the figures defines a quadrangular boarder, while the panel body opening 24 defines a circular shape, although it is contemplated that the panel body 16 and panel body opening 24 may define other shapes without departing from the spirit and scope of the present disclosure.

A resilient seal element 14 is coupled to the panel body 16 and includes a portion which extends radially inward from the panel body 16 into the panel body opening 24. According to one embodiment, the resilient seal element 14 is formed from a water-resistant elastomeric material. The resilient seal element 14 includes a first surface 32, an opposing second surface 34, and a seal element opening 36 having a defined contour complimentary to the defined contour of the boarder of the electrical junction box 12. In the exemplary embodiment, the defined contour of the seal element opening 36 is quadrangular, and is dimensioned similarly to that of the outer contour of the electrical junction box 12. In this regard, when the electrical junction box 12 is advanced through the seal element opening 36, the size of the seal element opening 36 causes the resilient seal element 14 to engage the outer surface of the electrical junction box 12, thereby deforming the resilient seal element 14 and placing the resilient seal element 14 in tension. Furthermore, a circumferentially compressive force is exerted on the outer surface of the electrical junction box 12 by the resilient seal element 14 to form the fluid-tight seal therebetween.

According to one embodiment, the panel body 16 and resilient seal element 14 have different rigidities. In particular, the panel body 16 is of a first rigidity and the resilient seal element 14 is of a second rigidity less than the first rigidity. In this regard, the panel body 16 is more resistant to flexing and bending than the resilient seal element 14. The enhanced flexibility of the resilient seal element 14 allows the resilient seal element 14 to flex and conform to the outer surface of the electrical junction box 12 to form a fluid tight seal around the electrical junction box 12.

In the exemplary embodiment, the resilient seal element 14 includes an annular attachment element 38 peripherally located relative to a central body portion 40, with the annular attachment element 38 being specifically configured to facilitate connection between the resilient seal element 14 and the panel body 16. The resilient seal element 14 includes a first flange 42 extending along a portion of the first surface 20 of the panel body 16 and an opposing second flange 44 extending along a portion of the second surface 22 of the panel body 16, with the first and second flanges 42, 44 forming annular channel or attachment cavity therebetween. A radially inward portion of the panel body 16, including the inner edge 28, is received within the annular channel to connect the resilient seal element 14 to the panel body 16. The resilient seal element 14 may be connected to the panel body 16 via an adhesive, ultrasonic welding, molding, or through the use of other fastening means or techniques known by those skilled in the art. When the resilient seal element 14 is attached to the panel body 16, at least a portion of the resilient seal element 14 extends radially inward from the inner edge 28 of the panel body 16 and over the panel body opening 24.

Due to the relative positions of the panel body 16 and the resilient seal element 14, and in particular, the panel body 16 being radially outward relative to the resilient seal element 14, and the resilient seal element 14 being radially inward relative to the panel body 16, the panel body 16 may be referred to as an “outer element” or outer portion, while the resilient seal element 14 may be referred to as an “inner element” or inner portion.

According to one embodiment, the flashing panel 10 is formed independent of a flange or other structure which protrudes perpendicularly relative to the plane defined by the panel body 16. Along these lines, the flashing panel 10 may be easier to manufacture and store, since the flashing panel 10 is essentially planar, particularly when compared to those flashing panels having a flange projecting from the panel body. Furthermore, flashing panels having projecting flanges are typically designed for use with an electrical box having specific dimensions. The elastomeric qualities of the resilient seal element 14 of the flashing panel 10 allows the resilient seal element 14 to adapt to minor variations in dimension in electrical junction boxes.

With the basic structure of the flashing panel 10 described above, the following discussion will focus on an exemplary use of the flashing panel 10. As noted above, the flashing panel 10 is used to create a circumferential, fluid tight seal around an electrical box 12 for the purposes of mitigating moisture entry into a building along the external surface of the electrical box 12.

Referring now specifically to FIG. 3, there is shown electrical box 12, a shear panel 50, studs 52, and flashing panel 10 spaced from the shear panel 50 and the electrical box 12. The shear panel 50 includes an opening 48 formed therein, with the electrical box 12 extending through the opening 48. The flashing panel 10 is positioned relative to the electrical box 12, such that the opening 36 in the resilient seal element 14 is aligned with the electrical box 12.

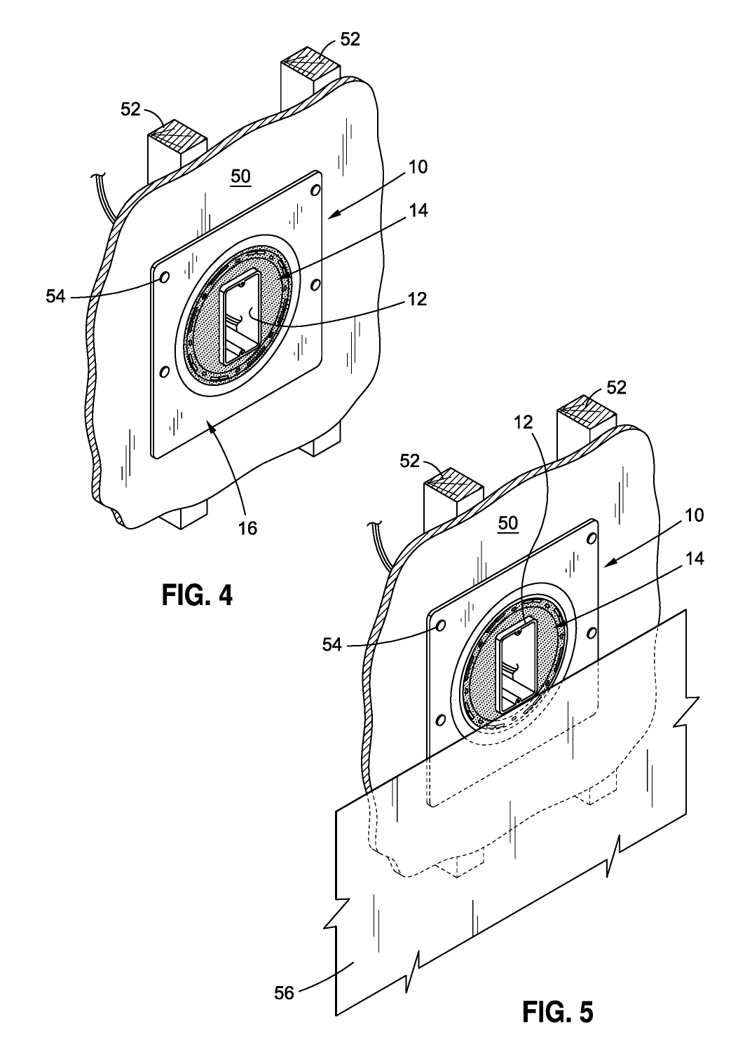

The flashing panel 10 is then moved toward the shear panel 50, which causes the electrical box 12 to extend through the opening 36 in the resilient seal element 14. Passage of the electrical box 12 through the opening 36 causes the resilient seal element 14 to circumferentially engage the outer surface of the electrical box 12, thereby forming a fluid-tight seal therebetween. The flashing panel 10 is then secured to the shear panel 50 through the use of mechanical fasteners 54, such as nails, screws, or the like, as shown in FIG. 4. It is also contemplated that adhesives may also be used to install the flashing panel 10. When the flashing panel 10 is connected to the shear panel 50, a portion of the electrical box 12 extends from the resilient seal element 14.

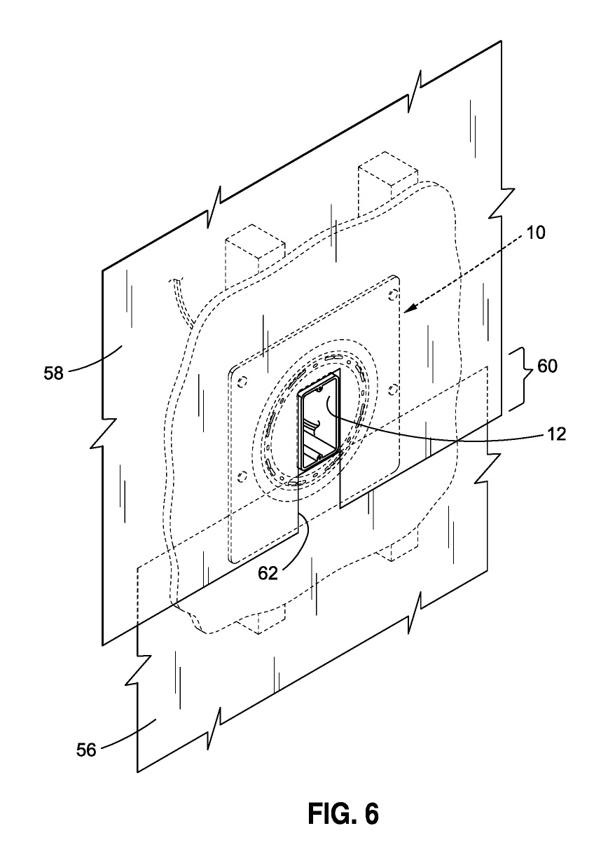

Referring now to FIGS. 5 and 6, weatherproofing sheets are installed over the flashing panel 10 to provide additional protection against moisture intrusion into the building along the outer surface of the electrical box 12. A lower weatherproofing sheet 56 is placed over a lower portion of the flashing panel 10, with an upper edge of the lower weatherproofing sheet 56 being disposed adjacent a lower portion of the electrical box 12, as shown in FIG. 5. An upper weatherproofing sheet 58 is placed over the upper portion of the flashing panel 10, and an upper portion of the lower weatherproofing sheet 56 to define an overlapping region 60. The upper weatherproofing sheet 58 includes a cutout 62 having a width that corresponds to the width of the electrical box 12, to allow the upper weatherproofing sheet 58 to extend around the electrical box 12. However, the width of the cutout 62 is preferably not so large as to create a significant gap between the sides of the electrical box 12 and the upper weatherproofing sheet 58. Rather, the upper weatherproofing sheet 58 preferably closely conforms to the outer surface of the electrical box 12 to protect against moisture passage.

An exemplary weatherproofing sheet is Tyvek™ HomeWrap™, although other weatherproofing sheets known in the art may also be used.

Once the weatherproofing sheets 56, 58 are arranged, an external covering may be applied. The external covering may be stucco, brick, siding, or any other external covering element known in the art. The electrical box 12 extends through an opening in the external cover to allow for access to the conduit 12 outside the building.

Although FIGS. 3-6 show the use of the flashing panel along with a shear panel 50, it is understood that the use of a shear panel 50 is not required, particularly in areas that are not as susceptible to seismic activity. In those instances, the flashing panel 10 may be connected directly to one or more studs 52 or other structural support members.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A flashing panel for use with an electrical junction box including a boarder having a defined contour, the flashing panel comprising:
a panel body having a first surface, an opposing second surface, and a panel body opening extending from the first surface to the second surface; and
a resilient seal element coupled to the panel body and extending radially inward from the panel body into the panel body opening, the resilient seal element having a seal element opening having a defined contour complimentary to the defined contour of the boarder of the electrical junction box, the seal element opening being sized to allow the electrical junction box to at least partially extend therethrough, with the resilient seal element deforming as the electrical junction box is extended through the seal element opening so as to form a fluid tight seal around the boarder of the electrical junction box.

2. The flashing panel recited in claim 1, wherein the panel body is formed from a polymeric material.

3. The flashing panel recited in claim 1, wherein the panel body defines a quadrangular boarder.

4. The flashing panel recited in claim 1, wherein the panel body is generally rigid.

5. The flashing panel recited in claim 1, wherein the resilient seal element is formed from an elastomeric material.

6. The flashing panel recited in claim 1, wherein the resilient seal element is formed from a water resistant material.

7. The flashing panel recited in claim 1, wherein the seal element opening is quadrangular.

8. The flashing panel recited in claim 1, wherein the resilient seal element includes an annular attachment element engaged with the panel body.

9. The flashing panel recited in claim 1, wherein the annular attachment element includes:
a first flange extending along a portion of the first surface of the panel body; and
a second flange extending along a portion of the second surface of the panel body;
the first and second flanges defining an attachment cavity therebetween, the panel body being received within the attachment cavity.

10. The flashing panel recited in claim 1, wherein the panel body extends within a panel plane, the flashing panel being formed independent of a flange extending generally perpendicular to the panel plane.

11. The flashing panel recited in claim 1, wherein the seal element opening extends in a first direction by approximately 4.875 inches, and in a second direction by approximately 2.750 inches, the second direction being generally perpendicular to the first direction.

12. A flashing panel adapted for use with an electrical junction box, the flashing panel comprising:
an outer element having a first opening formed therein, the outer element being of a first rigidity; and
a resilient inner element coupled to the outer element and extending radially inward from the outer element into the first opening, the resilient inner element including a second opening having a defined contour complimentary to the defined contour of the boarder of the electrical junction box, the second opening being sized to allow the electrical junction box to at least partially extend therethrough, with the resilient inner element deforming as the electrical junction box is extended through the second opening so as to form a fluid tight seal around the boarder of the electrical junction box;
the resilient inner element being of a second rigidity less than the first rigidity.

13. The flashing panel recited in claim 12, wherein the outer element is formed from a polymeric material.

14. The flashing panel recited in claim 12, wherein the resilient inner element is formed from an elastomeric material.

15. The flashing panel recited in claim 12, wherein the resilient inner element is formed from a water resistant material.

16. The flashing panel recited in claim 12, wherein the second opening is quadrangular.

17. The flashing panel recited in claim 12, wherein the resilient seal element includes an annular attachment element engaged with the panel body.

18. The flashing panel recited in claim 12, wherein the annular attachment element includes:
a first flange extending along a portion of the first surface of the panel body; and
a second flange extending along a portion of the second surface of the panel body;
the first and second flanges defining an attachment cavity therebetween, the panel body being received within the attachment cavity.

19. The flashing panel recited in claim 12, wherein the panel body extends within a panel plane, the flashing panel being formed independent of a flange extending generally perpendicular to the panel plane.

20. The flashing panel recited in claim 1, wherein the seal element opening extends in a first direction by approximately 4.875 inches, and in a second direction by approximately 2.750 inches, the second direction being generally perpendicular to the first direction.
